(19) United States
(12) Patent Application Publication
(10) Pub. No.: US 2006/0224622 A1
(43) Pub. Date: Oct. 5, 2006

(54) Mobile client synchronization and upgrading

(75) Inventor: Raghuram Velega, Foster City, CA (US)

Correspondence Address: Bingham McCutchen, LLP;Suite 1800, Three Embarcadero, San Francisco, CA, 94111-4067, US

(73) Assignee: E.piphany, Inc., San Mateo, CA (US)

(21) Appl. No.: 11/096,760

(22) Filed: Mar. 31, 2005

(51) Int. Cl. G06F 7/00

(52) U.S. Cl. 707/104.1

(57) ABSTRACT

Upgrading a mobile client is described, including exporting a deployment unit, the deployment unit including an item, an action, and a target, and logic configured to perform the action on the item at the target, importing the deployment unit from a file system to a master, applying the action on the item at the target on the master, and committing the deployment unit from the master to the mobile client, wherein the deployment unit executes logic configured to apply the action on the item at the target on the mobile client.

### CROSS REFERENCE TO RELATED APPLICATIONS

This application is a continuation of co-pending U.S. patent application Ser. No. Not-Yet-Assigned (Attorney Docket No. 2024489-7045242001-EPI-031US) entitled “Mobile Client Synchronization and Upgrading” filed Mar. 30, 2005 which is incorporated herein by reference for all purposes.

### FIELD OF THE INVENTION

The present invention relates generally to software, and more specifically, to mobile client synchronization and upgrading.

### BACKGROUND OF THE INVENTION

Applications running on mobile systems such as wireless computers, notebooks, laptops, and other computing devices have enabled users to perform various activities while remotely located from a local network. By allowing users to work remotely, productivity and efficiency has increased by allowing field personnel (e.g., sales, maintenance, support, remote developers, and other employees) to access information from a host (e.g., LAN, MAN, WAN, WLAN, and others) network. Computer programs, software, or applications (hereafter “applications”) on mobile devices may be used for a variety of functions including sales force automation (SFA), customer relationship management (CRM), enterprise resource planning (ERP), field personnel management, and others. However, conventional mobile devices have various problems.

Problems with conventional mobile devices often involve keeping data current, synchronization, and keeping applications current with new releases or versions. For example, when a mobile device (e.g., client) is disconnected from the host network, data communication with the home network is not available. The disconnected state prevents updated information from reaching the mobile device. Field personnel relying upon their mobile device to provide current information may not received the most current or updated product or service data, forms, and other information. Additionally, mobile users often depend upon information that can only be updated when they are logged into the host network. Another problem is the inability to retrieve, pass/send, and update information between a home server and other mobile devices that are part of the same remote network. Mobile devices act as clients on a wireless network communicate with a central or host server, and often are unable to pass data to other clients. In other words, changes made on a client are not passed to other clients operating in different regions. For example, a change made to a client in Chicago is unable to be passed to other clients in New York, Los Angeles, or Miami using conventional solutions. Further, conventional solutions rely upon specialized applications residing on the mobile client to enable a secure connection in order to perform synchronizing or upgrading tasks. However, these solutions often consume a large amount of processor and memory resources on mobile devices, which limits the capability of conventional mobile devices.

Thus, what is needed is a solution for mobile client synchronization and upgrading while avoiding the limitations of conventional techniques.

### BRIEF DESCRIPTION OF THE DRAWINGS

Various embodiments of the invention are disclosed in the following detailed description and the accompanying drawings:

FIG. 1 illustrates an exemplary data communication network for mobile client synchronization;

FIG. 2A illustrates an exemplary system for mobile client synchronization;

FIG. 2B illustrates an alternative view of an exemplary system for mobile client synchronization;

FIG. 3 illustrates an exemplary transaction table;

FIG. 4 illustrates an exemplary overall process for mobile client synchronization;

FIG. 5 illustrates an exemplary process for replaying a change;

FIG. 6 illustrates an exemplary process for creating a deployment unit;

FIG. 7A illustrates an exemplary process for mobile client upgrading;

FIG. 7B illustrates an alternative exemplary process for mobile client upgrading;

FIG. 7C illustrates an exemplary process for mobile client upgrading using a slice;

FIG. 8 illustrates an exemplary process for creating a transaction;

FIG. 9 illustrates an exemplary process for packaging;

FIG. 10 illustrates an alternative exemplary overall process for mobile client synchronization; and

FIG. 11 is a block diagram illustrating an exemplary computer system suitable for mobile client synchronization.

### DETAILED DESCRIPTION OF THE PREFERRED EMBODIMENTS

The invention can be implemented in numerous ways, including as a process, an apparatus, a system, an instruction set on a computer readable medium such as a computer readable storage medium or a computer network wherein program instructions are sent over optical or electronic communication links. In this specification, these implementations, or any other form that the invention may take, may be referred to as techniques. In general, the order of the steps of the disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

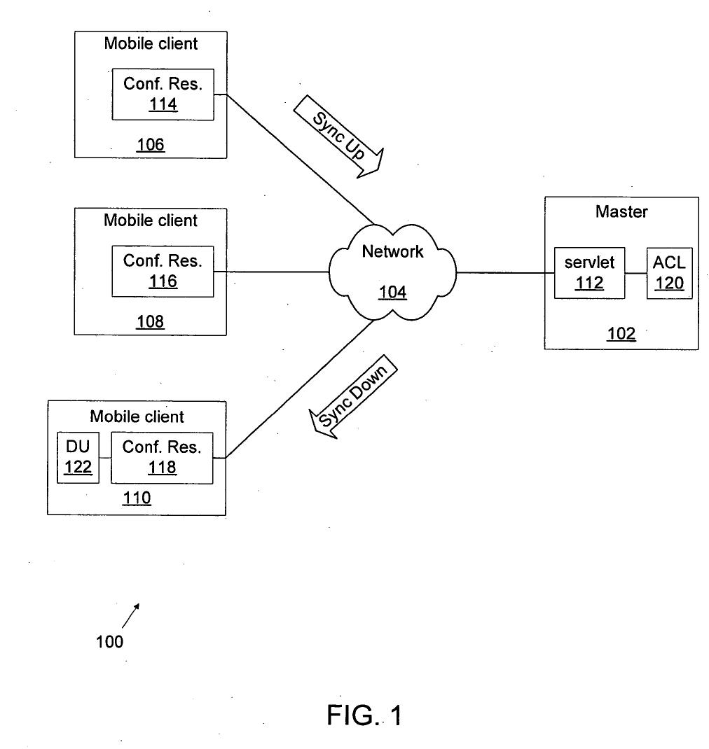

FIG. 1 illustrates an exemplary data communication system for mobile client synchronization and upgrading. In some embodiments, data communication system 100 includes master server (hereafter “master”) 102, network 104, mobile clients 106-110, servlet 112, conflict resolution modules 114-118, access control logic (ACL) 120, and deployment unit 122. Here, master 102 may be implemented as a server or other host machine. Mobile clients 106-110 may be implemented as mobile devices that are configured to connect to master 102. Embodiments of mobile devices may include personal digital assistants (PDA), laptop/notebook computers, mobile computing devices, mobile phones, or other types of wireless data communication devices. In other embodiments, the number of components may be varied. For example, additional mobile clients or masters may be added. Data may be synchronized between master 102 and mobile clients 106-110 by using logic within ACL 120 to control synchronization or upgrading functions (described in greater detail below). ACL 120 provides logic, rules, and other criteria for controlling synchronization in system 100. Conflict resolution on master 102 may be performed by logic included in ACL 120. On mobile clients 106-110, conflict resolution is conducted by conflict resolution modules 114-118, which handle conflicting updates or changes. ACL 120 may also provide permissioning capabilities that determine whether mobile client 108 has permission to read or write data to master 102 for synchronization or updating purposes. Data communication includes synchronization and upgrading operations (as described below).

Here, data communication uses a web server environment. In some embodiments, a web connection is established using simple object access protocol (SOAP)-encapsulated messages with attached documents that are transferred between master 102 and mobile clients 106-110. Encapsulated messages and attached XML documents are interpreted and handled by conflict resolution modules 114-118 according to a data transport protocol such as SOAP. Documents may include files, objects, or other data to perform changes to data stored on master 102 or mobile clients 106-110. In some embodiments, changes describe differences between current and updated information used by an application. Changes may also be described as differential data.

When changes occur, data indicating differences between current and new information (i.e., changes to either operational data or metadata) may be stored as transactions (described in greater detail below) and packaged as documents, attached to SOAP-based messages. Transactions are treated as objects, such as business objects or “BIOS,” as developed by E.piphany, Incorporated of San Mateo, Calif. Objects include operational data (e.g., actual text entries on a form) and metadata (e.g., data used to describe the format and presentation of information in, say, a web browser) and may be packaged in a document attached to a SOAP-message.

As a transport protocol, SOAP provides a web-based protocol that determines how to encapsulate data exchanged between web clients and servers. Using the protocol, messages may be interpreted and processed to enable information to be viewed in a web browser. In some embodiments, SOAP-based messages may be used to transport messages with attachments (e.g., XML documents). Attachments may include data for synchronizing and updating information related to changes that occurred over a given period of time on master 102 or mobile clients 106-110. Data exchanged between master 102 and mobile clients 106-110 are transferred using objects (e.g., files, documents, objects, XML documents, and the like) that are attached to SOAP messages, which are interpreted and handled using the SOAP protocol. If a synchronization is performed by sending data from mobile clients 106-110 to master 102, a “sync up” is performed (as shown). If a synchronization is being performed by sending data from master 102 to mobile clients 106-110, a “sync down” is performed (as shown). Synchronization operations (e.g., sync up, sync down) may also be performed differently, depending upon whether a network or web connection is present. For example, if a web connection is present, a user may log into master 102 remotely and perform an “online sync” from mobile clients 106-110. If a web connection is not present, then an “offline sync” may be performed. An offline sync does not require a user to log into master 102 using, for example, a username and password. Instead, when a user selects an icon from a user interface (e.g., drop-down menu, icon, and the like), mobile client 110 retrieves data from master 102 as an XML document with changes intended for various items on the mobile client. An item may be a field, entry, or other data element (e.g., “Name,” “Company,” “Account Number,” and the like). If a connection has not been established, then mobile client 110 established a connection and then retrieves data from master 102, but does so without requesting the user to log into master 102.

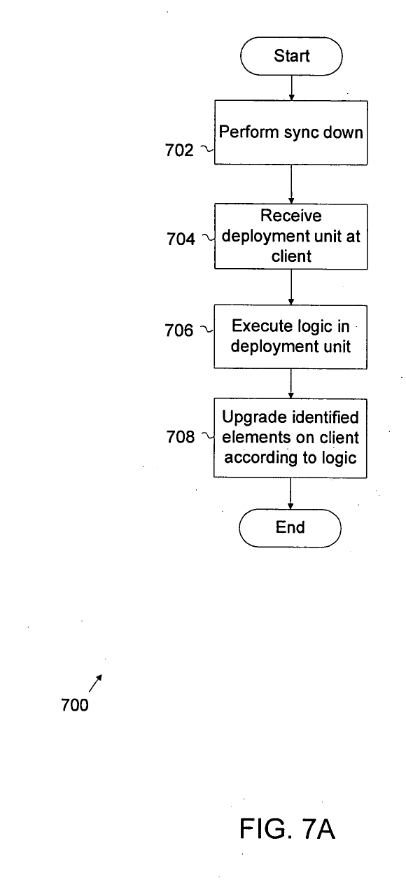

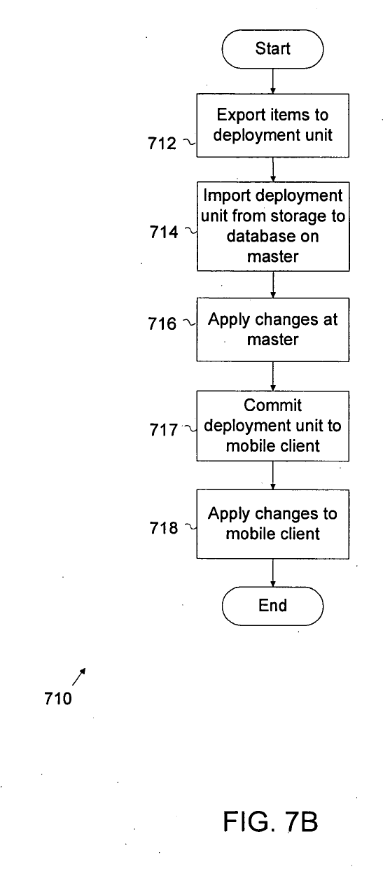

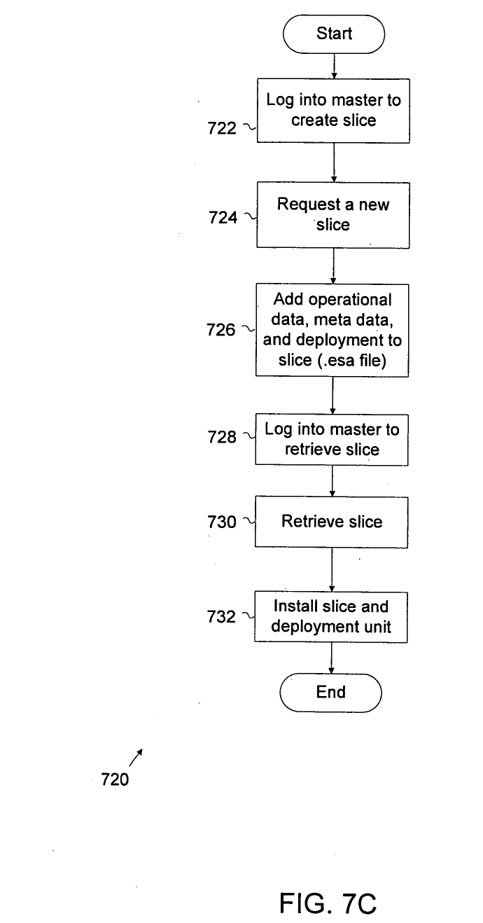

System 100 may also be used to update mobile client 110 by using deployment unit 122. In some embodiments, deployment unit 122 may be used to upgrade an application on mobile client 110 (i.e., by performing a sync down, as described in FIG. 7A) or to configure a new mobile client as a “slice” (described in greater detail below in connection with FIG. 7B). Deployment unit 122 may also include file configuration changes and associated data such as property files, third party libraries, SQL scripts, XML files and documents, HTML files, text files, and the like. Here, deployment unit 122 has been sent by master 102 through network 104 to mobile client 110. Deployment unit 122 may be implemented using a jar file that includes items such as a business interface object (BIO) or files containing operational data and metadata for performing changes. Actions include write, replace, delete, modify, add, or other similar functions that may be performed on a data element or item. A target may be a destination where the indicated changes are applied (e.g., master 102, mobile client 110). Deployment unit 122 may also be configured to include SQL scripts, applications, and logic configured to replay actions on items at a target (i.e., mobile client 110). In some embodiments, deployment unit 122 may also include logic that determines a sequence for executing actions, what actions to perform on an item (i.e., data element), and the targets for the actions on either master 102 or mobile clients 106-110. Logic included in deployment unit 122 may also be customized based on actions, items, and targets. For example, users at master 102 may create rules that are added to logic in deployment unit 122. Rules may specify an action which in turn uses a particular extension that identifies program code (e.g., Java) for performing the action on an item at a target (e.g., master 102, mobile clients 106-110). In other words, a rule may specify that a particular data element on mobile client 110 is to be modified based on data included in the jar file of deployment unit 122. Deployment unit 122 may also be used for different purposes. In other embodiments, variations of system 100 may be implemented and are not limited to the components, features, functionality, or techniques described above.

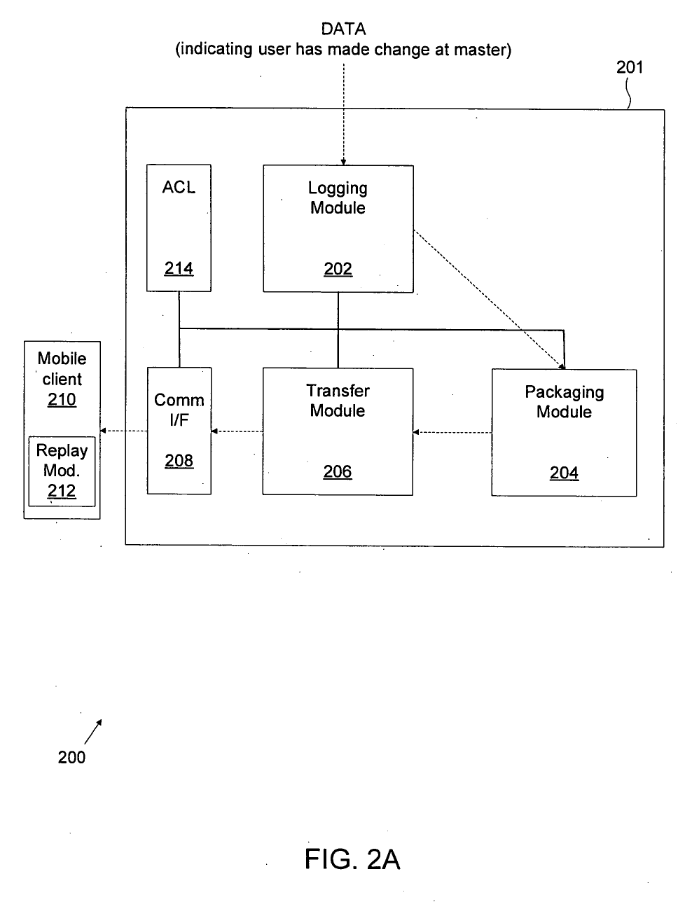

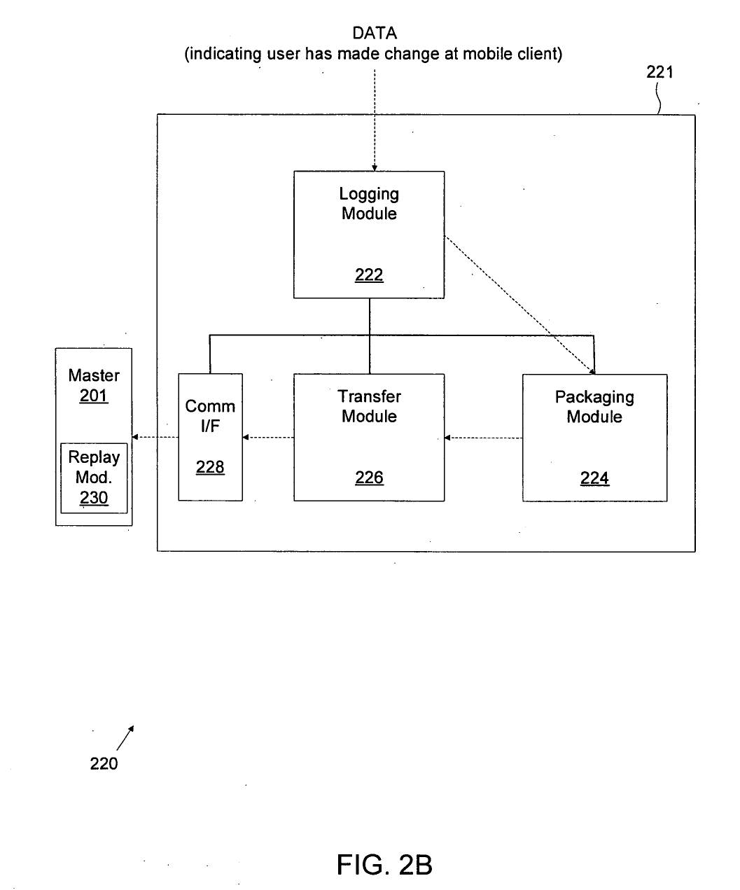

FIG. 2A illustrates an exemplary system for mobile client synchronization and upgrading. Here, system 200 includes master 201, which has several modules, including logging module 202, packaging module 204, transfer module 206, communication interface module 208 (for communication with mobile client 210), and ACL 214. Mobile client 210 also include replay module 212, which is used to replay changes to items (i.e., data elements) located on mobile client 210. The dashed, arrow-head lines represent the flow of data associated with mobile client synchronization and upgrading between logging module 202, packaging module 204, transfer module 206, communication interface module 208, and ACL 214. ACL 214 provides logic, rules, and other criteria for controlling synchronization in system 200. ACL 214 also provides permissioning capabilities that determine whether mobile client 210, for example, has permission to read or write data on master 201 for synchronization or updating purposes. In some embodiments, data is exchanged between master 201 and mobile client 210. The number of mobile clients may be varied and is not limited to the implementation shown. Further, the functionality of master 201 may also be implemented on mobile client 210, enabling synchronization and upgrading.

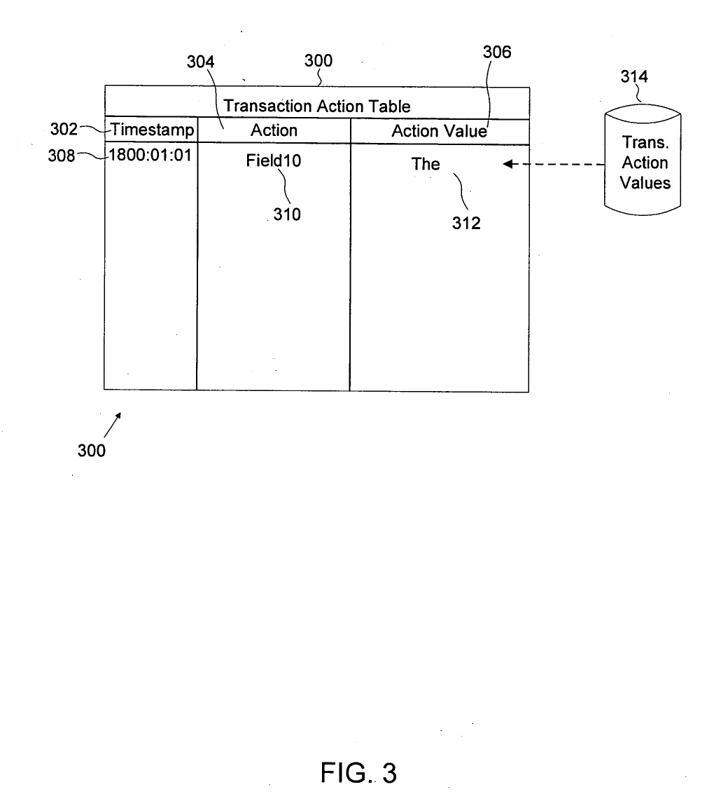

Here, master 201 may be implemented as a web-based system for exchanging data between a master (e.g., server) and one or more mobile clients to synchronize data. In some embodiments, a change occurs and data indicating the change is received by logging module 202. Logging module 202 logs the changes as transactions in, for example, a table (i.e., transaction action table). Transactions may be further specified in terms of individual transaction actions (hereinafter “actions”), which are logged or stored in a database as directed by logging module 202. In some embodiments, transactions may be logged in a transaction table, such as that described below in FIG. 3. In other embodiments, transactions may be logged in different types of data structures, including other types of tables, queues, hashes, databases, and the like.

Referring back to FIG. 2A, after logging a change as a transaction, packaging module 204 adds the transactions to an object. An object may be a set of processes or instructions that, when the object is instantiated, are executed. An object may also be a document formatted using languages such as XML, SGML, HTML, and others. Here, transactions are packaged in an XML document. In other embodiments, transactions may be packaged differently. Once packaged, the message and attached XML document is sent to transfer module 206, which determines a destination and, working with communication interface 208, encapsulates the message and attached document prior to sending it to mobile client 210. The message and attached document are encapsulated according to a data transport protocol (e.g., SOAP).

Packaging and transferring a document, which may include one or more transactions, uses a data encapsulation protocol (e.g., SOAP). The data encapsulation protocol enables endpoints (e.g., master 201, mobile client 210, and the like) to interpret, forward, and handle an object after it is received. For example, an XML document that contains one or more transactions may be forwarded, received, interpreted, and handled based on SOAP-based header data used to transfer the object from master 201 to mobile client 210. Likewise, a data encapsulation protocol may also be used to transfer objects from mobile client 210 to master 201. When an object is received at mobile client 210 or master 201, replay module 212 “replays” or changes data, according to the transactions included in the XML document. Replaying a transaction modifies, deletes, or adds data to targeted items at mobile client 210. Replaying may be performed to update, upgrade, modify, delete, or add data to various items on mobile client 210. The modules shown and described in FIG. 2A are examples and variations may be made in other implementations and are not limited to the components, features, and functionality described above.

FIG. 2B illustrates an alternative view of an exemplary system for mobile client synchronization and upgrading. Here, system 220 includes mobile client 221 in data communication with master 201. In some embodiments, master 201 may be implemented as described above in FIG. 2A. Mobile client 221 includes logging module 222, packaging module 224, transfer module 226, and communication interface (I/F) 228. Master 201 includes replay module 230, which replays changes to items. As discussed above, logging module 222, packaging module 224, transfer module 226, and communication interface (I/F) 228 perform similar functions to those described above for logging module 202, packaging module 204, transfer module 206, communication interface module 208 in FIG. 2A. Replay module 230 replays changes received during a sync down operation. The changes are replayed on master 201, which causes changes indicated to be performed on items located on master 201.

FIG. 3 illustrates an exemplary transaction table. In some embodiments, transaction action table 300 (also referred to as a “transaction table”) may be used to store data related to a change or update that has occurred in a master-mobile client system, such as that described above for FIG. 2A. Changes may be categorized as transactions, which may be further described in terms of actions, each of which may have a specific value assigned. Here, three columns are shown: time stamp 302, action 304, and action value 306. Each column may include one or more entries, each of which may be data associated with a transaction. Data in each column may also represent changes made by a user at either master 201 or mobile client 210 (FIG. 2A).

As an example, if “field10” was previously “Company” and a user enters a change to modify “field10” to read “The Company”, then the transaction action table is modified with a transaction action for “field10” that indicates data that describes the addition of “The.” Sample values for timestamp 308, action 310, and action value 312 are provided for purposes of illustration. More or fewer columns, fields, and values may be used and are not limited to the embodiments shown above. Each of the sample values 308-312 may be stored in a database. In some embodiments, action values 306 may be a “one-to-many” table, providing multiple values stored in database 314. Other databases may be used to store other values in transaction action table 300.

Transaction action table 300 is used to store data related to changes that have occurred in data held at master 201 or mobile client 210 (FIG. 2A). By organizing changes as transactions, data associated with changes may be exchanged between two endpoints to synchronize and update master 201 or mobile client 210 using a web-based interface. As an example, a web-based interface may include a browser pointed to a particular web address, from which SOAP-encapsulated messages and attachments may be retrieved. Techniques such as these enable synchronization and updating over a web connection without requiring proprietary or specialized software clients or applications at the client.

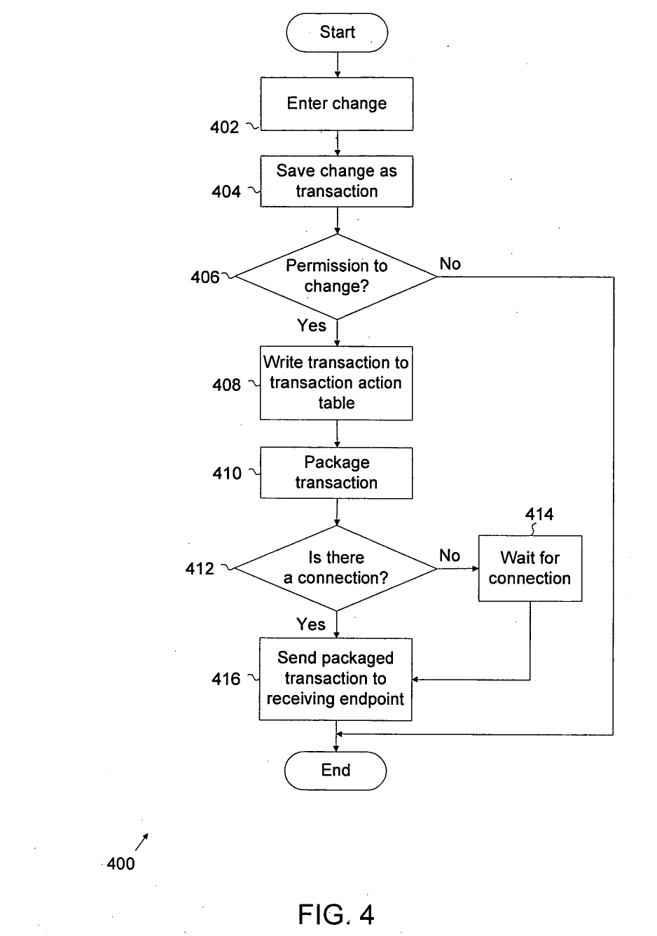

FIG. 4 illustrates an exemplary overall process 400 for mobile client synchronization. As an example, a field worker may use a mobile device to launch an application that allows her to enter sales data. Launched from a web browser, the data may be entered in a field. A specific operation may be performed by selecting a sync operation from a pull down menu in a user interface. Here, process 400 illustrates an overall technique for mobile client synchronization between master 201 and mobile client 210 (FIG. 2A). Initially, a user changes data on a sending endpoint, which may be either a mobile client or master (402). As an example, a salesperson enters updated information for a potential client or sales lead into a CRM application on her mobile device. As another example, a user may make a global change to a sales form that needs to be sent to all sales personnel who are working remotely. When a change is made, the change is saved on the sending endpoint to be used to modify an object (404). Next, ACL performs a check to determine whether the user has permission to make the indicated change (406). If the user has permission to make the indicated change, then the change is logged (i.e., written) as a transaction in a transaction action table (408). If the user does not have permission, then the process ends. However, if the user has permission to make the indicated change, then the transaction is packaged using a data encapsulation protocol (e.g., SOAP) and attaching the packaged transaction to an XML document (410).

A determination is made as to whether a web connection is present (412). If a web connection is not present, then the sending endpoint (e.g., master 102 or mobile clients 106-110 (FIG. 1)) waits for a web connection to be established prior to pushing (i.e., sending) the packaged transaction asynchronously to a receiving endpoint (414). A receiving endpoint may also be implemented as a master or mobile client. If a web connection is present, then the package is sent to the receiving endpoint synchronously (416). Although a single change and transaction are described above, multiple changes or transactions may be handled using the above process.

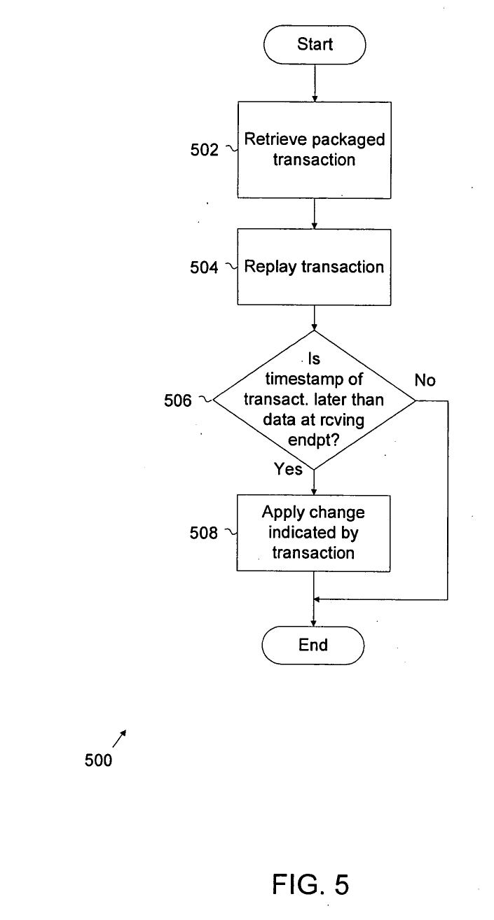

FIG. 5 illustrates an exemplary process 500 for replaying a change. In some embodiments, when a packaged transaction is sent by a sending endpoint as an attachment to a message, the transaction is replayed at the receiving endpoint. As an XML document, a transaction may be attached to a SOAP-encapsulated message, which is retrieved at a receiving endpoint (502). The encapsulated message includes transaction actions, each of which indicates a change to data stored on the receiving endpoint. Once received, the attachment is interpreted using a data encapsulation protocol (e.g., SOAP) and the transactions are replayed at the receiving endpoint (504). Replaying the transactions causes the action values of each action within the transaction to be compared to action values already stored on the receiving endpoint (506). The comparison is made based on a timestamp for the particular action and, if the transaction being replayed has a later time stamp than the stored/current transaction, then the action value for the stored/current transaction is written to the target location (508). If the timestamp of the transaction is earlier than the timestamp on the target data (i.e., the data that will be updated if the transaction is replayed), then the transaction is not replayed and the process ends. An earlier timestamp indicates that the transaction sent by the sending endpoint occurred prior to a subsequent change made to the same data at the receiving endpoint.

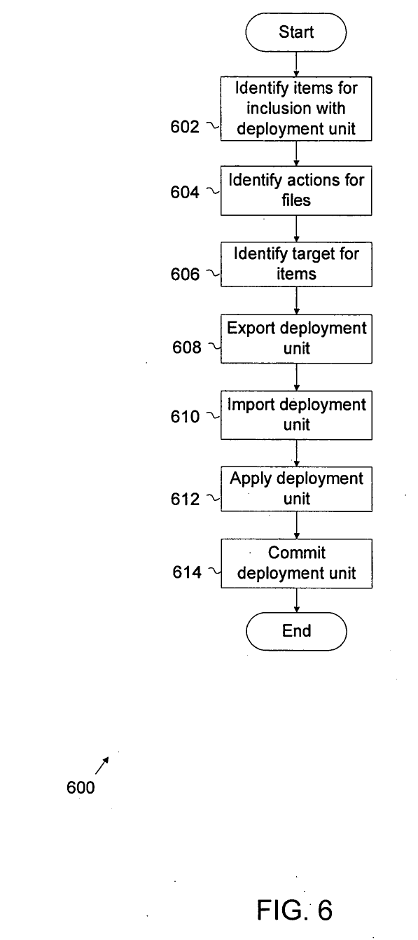

FIG. 6 illustrates an exemplary process 600 for creating a deployment unit. In some embodiments, upgrading an application on a mobile client may be performed by using a deployment unit. Upgrading applications on mobile clients are performed by using a sync down. When a deployment unit is created, items are identified for inclusion (602). In some embodiments, items may be files, objects (e.g., BIOS), documents, applications, program code, operational data, metadata, extensions, libraries or other data elements that can be used to upgrade a mobile client. Items are added to a jar (i.e., Java archive) file, which may be used to create a deployment unit. Actions may be identified for a file, indicating what needs to be done with the file while applying the changes on mobile (i.e., the logic or rules of applying the file are encoded in actions or extensions) (604). These items (e.g., files, BIOS) may be targeted to specific environments (e.g., mobile client, master) (606). In some embodiments, identifying targets may also include adding logic to a jar file (e.g., deployment unit) in order to instruct a deployment unit on how an application at a mobile client is upgraded. After identifying actions, items, and targets for inclusion, the deployment unit is exported to storage as a file system object (e.g., jar file) (608). Once the deployment unit is exported as a jar file to a file system, the deployment unit may be imported to master 201 (FIG. 2A) (610). In some embodiments, importing includes copying the jar file as a database object and sending the copy to master 201. After importing the deployment unit to master 201, the changed included in the items (e.g., files or bios), are applied on the master based on the logic or rules embedded in the actions and targets (612). Once the changes are applied to master 201, the deployment unit is committed for synchronization to the mobile (i.e., a copy of the deployment unit is retrieved from master 201 and sent to a mobile client) (614).

FIG. 7A illustrates an exemplary process for mobile client upgrading. After the process described in FIG. 6 is performed, a deployment unit may be sent to a mobile client to upgrade an application. Here, a sync down operation is performed to send the deployment unit to the mobile client (702). The deployment unit is received during the sync down operation as an attachment to a data transport protocol-encapsulated message (e.g., SOAP message) at the mobile client (704). Once received at the mobile application, logic included in the deployment unit directs the changes to be applied to the targeted elements (706). Logic included in the deployment unit directs the performance of actions by items (e.g., files or BIOS) on the mobile client, thus upgrading the mobile client (708).

FIG. 7B illustrates an alternative exemplary process for mobile client upgrading. In some embodiments, process 700 may also be described in phases, as shown by process 710. In an “export” phase, items (e.g., bios or files) are added to a deployment unit, associating actions and targets to these items, which also includes embedding logic that directs how to apply the items. The deployment unit is saved as a jar file on a file system or other storage. The jar file includes the physical file elements and data (as an XML file) and any associated logic for applying the items (712). During an “import” phase, the deployment unit is saved from storage (i.e., a file system) to a database on a master server (714). In an “apply” phase the changes in the deployment unit are propagated based on the logic (e.g., rules) associated with each item in the deployment unit to the master environment (e.g., if a SQL script is embedded in a deployment unit and is associated with an action of “execute” on metadata, the script is executed on the indicated metadata on the master) (716). In a “commit” phase, the deployment unit is propagated to the mobile client using a sync down or as a slice for performing an initial configuration of a new mobile client (717). Once committed to a mobile client, the changes in the deployment unit may be applied on the mobile based on the logic or rules associated with each item in the deployment unit (718).

FIG. 7C illustrates an exemplary process for mobile client upgrading using a slice. A “slice” may be a file having an extension such as “.esa” as developed by E.piphany Incorporated of San Mateo, Calif. A slice may include operational data and metadata and associated changes that may be copied onto a mobile client for purposes of configuring a new mobile client for network participation. Here, a user logs in (locally) to a master server to create a slice, which may be a .esa file (722). After logging into the master server, a slice is requested (724). Operational data and metadata are included in the slice. In some embodiments, file changes may be included in a deployment unit, which is a type of slice. After requesting a slice, an .esa file is created for the slice and operational data, metadata, and a deployment unit are added to the slice (726). From a mobile client, a user logs into the master server using, for example, a username and password (728). Once the user has logged in via, for example, a web connection to the master server, the slice may be retrieved (730). Once retrieved, the deployment unit and its associated files are installed to create a new profile and configure the new mobile client, which shares the same state as other mobile clients already configured (732). In other embodiments, this process may be varied and is not limited to the above description.

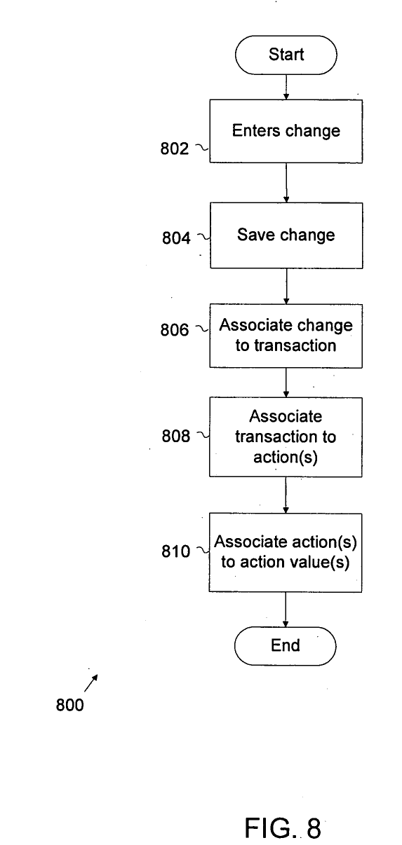

FIG. 8 illustrates an exemplary process 800 for creating a transaction. In some embodiments, transactions are created when a user enters a change (802). The user then saves the change at a mobile client or on a master (e.g., administration server) (804). Once saved, a mobile client synchronization system (e.g., FIG. 1 or 2) associates the change to a transaction (806). In some embodiments, a transaction is data that indicates a difference between stored or current data and new data that a user has entered. Transactions may be stored as objects or modified objects, such as business objects developed by E.piphany, Incorporated of San Mateo, Calif. After the change has been saved, the change is associated with a transaction, which is also associated with one or more actions (808). Actions indicate specific objects, fields, or items for changes. Subsequently, actions may have action values, which may be explicit or derived values for particular actions (810). Transactions, actions, and action values may be populated in transaction action tables (e.g., FIG. 3) or stored in other databases, repositories, and the like.

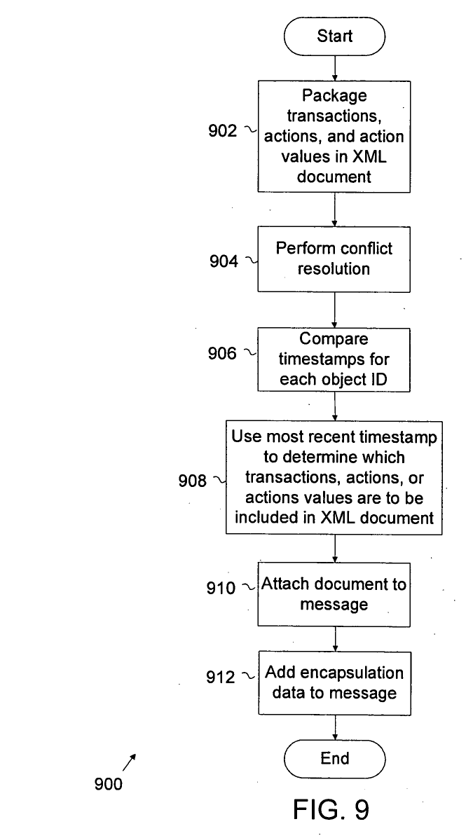

FIG. 9 illustrates an exemplary process for packaging. After transactions have been determined from changes and user permission has been verified to make the indicated changes, the transactions are packaged according to process 900. In some embodiments, a process may be used to package transactions for data transport between a master server and a mobile client, or vice versa. Here, transactions, actions, and action values are packaged in an XML document (902). In other embodiments, transactions, actions, and action values may be packaged in other types of documents or objects. Once packaged, conflict resolution is performed to determine whether any transactions should not be included (904). Conflict resolution may be performed based on timestamps for the transactions included in the XML document. Conflict resolution may be performed by using objectIDs to determine whether a change should be applied. Another technique for performing conflict resolution may be based on determining whether a user has permission to make a particular change to a field, form, item, or object. Still another technique for conflict resolution may use logic included in ACL 120 (FIG. 1). Another technique may use rules, parameters, or criteria also included in ACL 120 for resolving conflict between concurrent changes. Conflict resolution may also be performed using other techniques than those described above.

Here, conflict resolution is performed by comparing the timestamps for each object that represents a transaction, action, or action value (906). An object identifier (e.g., objectID) is used to compare two or more similar objects to determine the latest change (i.e., transaction, action, action value). During the comparison, the latest or most recent timestamp indicates the object that should be included in the XML document (908). After determining and adding the desired transactions to the XML document, the document is attached to a data transport message (910). After attaching the document to the message, encapsulation data (e.g., header data bits) are added to the message based on a data transport protocol in use (e.g., SOAP) (912). The above process may be performed for mobile client synchronization, upgrading, or other related functions.

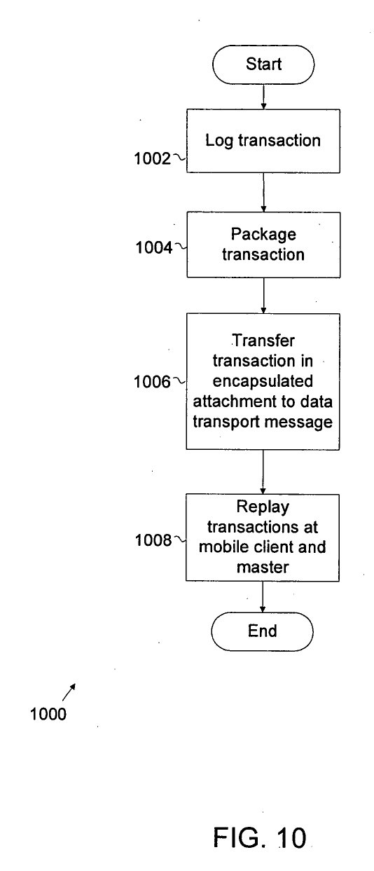

FIG. 10 illustrates an alternative exemplary overall process for mobile client synchronization. Here, an alternative process 1000 for performing mobile client synchronization is described. Transactions correlating to changes indicated by a user are logged in a transaction action table (1002). Once logged, transactions are packaged for data transport between master 102 and mobile clients 106-110 (FIG. 1) (1004). The packaged transactions are transferred between master 102 and mobile clients 106-110 as an attachment to a data transport message (i.e., a message sent at the data transport layer of an application) using a data transport protocol for interpretation, transmission, reception, and handling of the message at the endpoints of a connection (1006). Once the attached message has been received from the transfer, the transactions are replayed at the mobile client and the master in a synchronous manner (1008). This ensures that data at either the mobile client or the master are similar.

As an example, a salesperson enters a change to a form. The change is resolved into a transaction and stored in a transaction action table. The transaction is then included in an XML document that is attached to a SOAP message. The message is encapsulated using SOAP and is transmitted from the salesperson's mobile client to the master server. The master server receives the message and a SOAP-based servlet at the master server provides instructions on how to interpret and handle the attachment. When the message and the attached transactions have been received at the master server, the transactions are replayed at the mobile client and master.

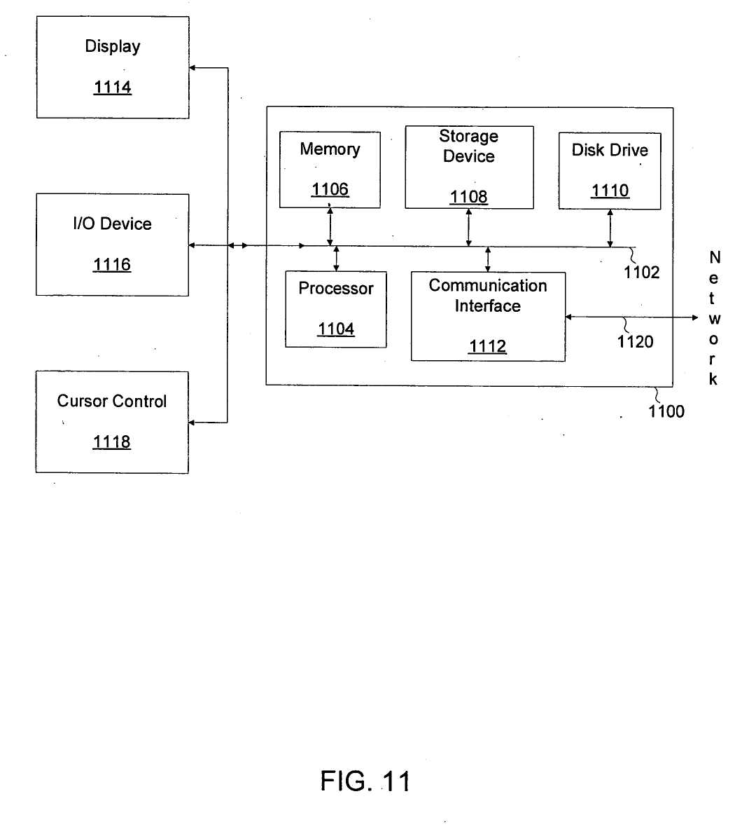

FIG. 11 is a block diagram illustrating an exemplary computer system suitable for mobile client synchronization. In some embodiments, computer system 1100 may be used to implement the above-described techniques. Computer system 1100 includes a bus 1102 or other communication mechanism for communicating information, which interconnects subsystems and devices, such as processor 1104, system memory 1106 (e.g., RAM), storage device 1108 (e.g., ROM), disk drive 1110 (e.g., magnetic or optical), communication interface 1112 (e.g., modem or Ethernet card), display 1114 (e.g., CRT or LCD), input device 1116 (e.g., keyboard), and cursor control 1118 (e.g., mouse or trackball).

According to one embodiment of the invention, computer system 1100 performs specific operations by processor 1104 executing one or more sequences of one or more instructions contained in system memory 1106. Such instructions may be read into system memory 1106 from another computer readable medium, such as static storage device 1108 or disk drive 1110. In alternative embodiments, hard-wired circuitry may be used in place of or in combination with software instructions to implement the invention.

The term “computer readable medium” refers to any medium that participates in providing instructions to processor 1104 for execution. Such a medium may take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In an embodiment of the invention, execution of the sequences of instructions to practice the invention is performed by a single computer system 1100. According to other embodiments of the invention, two or more computer systems 1100 coupled by communication link 1120 (e.g., LAN, PSTN, or wireless network) may perform the sequence of instructions to practice the invention in coordination with one another. Computer system 1100 may transmit and receive messages, data, and instructions, including program, i.e., application code, through communication link 1120 and communication interface 1112. Received program code may be executed by processor 1104 as it is received, and/or stored in disk drive 1110, or other non-volatile storage for later execution.

Although the foregoing embodiments have been described in some detail for purposes of clarity of understanding, the invention is not limited to the details provided. There are many alternative ways of implementing the invention. The disclosed embodiments are illustrative and not restrictive.

What is claimed:

1. A method for upgrading a mobile client, comprising:
exporting a deployment unit, the deployment unit including an item, an action, and a target, and logic configured to perform the action on the item at the target;
importing the deployment unit from a file system to a master;
applying the action on the item at the target on the master; and
committing the deployment unit from the master to the mobile client, wherein the deployment unit executes logic configured to apply the action on the item at the target on the mobile client.

2. The method recited in claim 1, wherein the deployment unit is a file.

3. The method recited in claim 1, wherein the deployment unit is a jar file.

4. The method recited in claim 1, wherein the deployment unit includes a file configuration change.

5. The method recited in claim 1, wherein the logic, when executed, determines how the action is applied on the item at the target.

6. The method recited in claim 1, wherein the deployment unit includes operational data.

7. The method recited in claim 1, wherein the deployment unit includes metadata.

8. The method recited in claim 1, wherein exporting the deployment unit further comprises packaging the deployment unit in a jar file.

9. The method recited in claim 1, wherein committing the deployment unit from the master to the mobile client further comprises sending the deployment unit as an attachment to a message.

10. The method recited in claim 1, wherein committing the deployment unit from the master to the mobile client further comprises sending the deployment unit as an attachment to a data transport message, wherein the attachment is encapsulated using a data transport protocol.

11. A system for upgrading a mobile client, comprising:
a memory for storing data;
a processor configured to create a deployment unit, the deployment unit including an item, an action, and a target, and logic configured to perform the action on the item at the target, the processor being further configured to export the deployment unit to a file system, to import the deployment unit from the file system to a master, to apply the action on the item at the target on the master, and to commit the deployment unit from the master to the mobile client, wherein the deployment unit executes logic configured to apply the action on the item at the target on the mobile client.

12. The system recited in claim 11, wherein the deployment unit is a file.

13. The system recited in claim 11, wherein the deployment unit has a file format of jar.

14. The system recited in claim 11, wherein the logic, when executed, determines how the action is applied on the item at the target on the master or the mobile client.

15. The system recited in claim 11, wherein the deployment unit includes operational data.

16. The system recited in claim 11, wherein the deployment unit includes metadata.

17. The system recited in claim 11, further comprising a packaging module configured to package the deployment unit in a jar file.

18. The system recited in claim 11, wherein the processor being further configured to commit the deployment unit from the master to the mobile client further comprises sending the deployment unit as an attachment to a message.

19. The system recited in claim 11, wherein the processor being further configured to commit the deployment unit from the master to the mobile client further comprises sending the deployment unit as an attachment to a data transport message, wherein the attachment is encapsulated using a data transport protocol.

20. A computer program product for upgrading a mobile client, the computer program product being embodied in a computer readable medium and comprising computer instructions for:
exporting a deployment unit, the deployment unit including an item, an action, and a target, and logic configured to perform the action on the item at the target;
importing the deployment unit from a file system to a master;
applying the action on the item at the target on the master; and
committing the deployment unit from the master to the mobile client, wherein the deployment unit executes logic configured to apply the action on the item at the target on the mobile client.
